(19) United States
(12) Patent Application Publication
(10) Pub. No.: US 2017/0175059 A1
(43) Pub. Date: Jun. 22, 2017

(54) WATER-SOLUBLE UNIT DOSE ARTICLE

(71) Applicant: The Procter & Gamble Company, Cincinnati, OH (US)

(72) Inventors: Karel Jozef Maria DEPOOT, Anzegem-Vichte (BE); Jean-Pol BOUTIQUE, Gembloux (BE); Laura ORLANDINI, Le Mont sur Lausanne (CH)

(21) Appl. No.: 15/372,443

(22) Filed: Dec. 8, 2016

(30) Foreign Application Priority Data
Dec. 16, 2015 (EP) 15200553.4
Oct. 7, 2016 (EP) 16192893.2

(51) Int. Cl. C11D 17/04; C11D 3/00; C11D 17/06; C11D 1/22; C11D 3/12; C11D 3/37; C11D 3/22; C11D 3/20; C11D 3/50; C11D 3/08; C11D 11/00; C11D 1/29

(52) U.S. Cl. CPC C11D 17/045; C11D 11/0017; C11D 17/042; C11D 3/001; C11D 17/06; C11D 1/22; C11D 1/29; C11D 3/373; C11D 3/225; C11D 3/2065; C11D 3/505; C11D 3/08; C11D 3/128

(57) ABSTRACT

A multicompartment water-soluble unit dose article that includes at least a first compartment and a second compartment: (a) where the first compartment includes a first composition that is a free-flowing non-compressed particulate composition, and where the first composition includes a fabric softening ingredient; and (b) where the second compartment includes a second composition that is a liquid composition, the liquid composition including less than 5% by weight of the liquid composition of a structuring agent, less than 15% by weight of the unit dose article of water and between 5% and 35% by weight of the unit dose article of non-aqueous solvent; and where the weight ratio of the first composition to the second composition is between 2:1 and 1:25.

### FIELD OF THE INVENTION

The present disclosure relates to water soluble unit dose articles comprising fabric softening ingredients.

### BACKGROUND OF THE INVENTION

Laundry detergents can be formulated in to water-soluble unit dose articles. Water-soluble unit dose articles are liked by consumers as offering a convenient and efficient means to dose an appropriate level of detergent into the wash. However, there is a desire to formulate a unit dose article that provides both cleaning and fabric softening benefits at the same time.

A problem with the addition of fabric softening actives is that they tend to reduce the rate of dissolution of the water soluble film. This in turn means that the water-soluble pouch not fully dissolve during the wash cycle leaving unsightly residues on fabrics. Without wishing to be bound by theory, it is believed that the fabric softening ingredients, especially those ingredients that are cationically charged, tend to stick to the water-soluble film. This sticking of the fabric softening ingredient to the film can retard the dissolution of both the fabric softening ingredient and the film.

This negative effect was previously addressed in WO2011163371 in which cationic fabric softening ingredients were added to the liquid laundry detergent composition in particulate form, where they existed dispersed throughout the liquid laundry detergent composition. However, an issue with such formulations is that ‘structurants’ are needed to ensure homogenous dispersion of the particulate fabric softening actives throughout the liquid laundry detergent composition. In the absence of structurants, the particulate material has a tendency to ‘sink’ to the bottom of the unit dose article and be both unsightly but also result in sticking of the high concentration of the fabric softening active to the film. However, structurants when formulated bring certain levels of water. This is undesirable as overall water levels need to be managed in water-soluble unit dose articles to prevent the film from prematurely dissolving. Furthermore, the particulate materials require a certain level of non-aqueous solvent to prevent the particles from swelling in the liquid detergent composition and negatively affecting the viscosity of the composition. A further complication is that a certain level of non-aqueous solvent is also required in the liquid laundry detergent composition to enable appropriate plasticization of the film.

Therefore, there is a need in the art for a water-soluble unit dose article comprising a fabric softening active, but which requires minimal use of structurant and exhibits excellent dissolution in the wash liquor.

It has surprisingly been found that the multicompartment unit dose article of the present invention overcame the above technical problem. Without wishing to be bound by theory, the fabric softening composition is formulated into a powder composition in one compartment wherein the liquid composition comprises minimal structurant and water. However, the weight ratio of the powder and liquid compositions are carefully balanced to ensure dissolution of the unit dose article overall is not negatively impacted, nor is the plasticization of the film.

### SUMMARY OF THE INVENTION

The present disclosure relates to a multicompartment water-soluble unit dose article comprising at least a first compartment and a second compartment;
a. wherein the first compartment comprises a first composition wherein the first composition is a free-flowing non-compressed particulate composition, and wherein the first composition comprises a fabric softening ingredient; and
b. wherein the second compartment comprises a second composition wherein the second composition is a liquid composition, and the liquid composition comprises less than 5% by weight of the liquid composition of a structuring agent, less than 15% by weight of the unit dose article of water and between 5% and 35% by weight of the unit dose article of non-aqueous solvent, and
wherein the weight ratio of the first composition to the second composition is between 2:1 and 1:25.

### DETAILED DESCRIPTION OF THE INVENTION

### Multicompartment Unit Dose Article

The present disclosure relates to multicompartment water-soluble unit dose article comprising at least a first compartment and a second compartment;
a. wherein the first compartment comprises a first composition wherein the first composition is a free-flowing non-compressed particulate composition, and wherein the first composition comprises a fabric softening ingredient; and
b. wherein the second compartment comprises a second composition wherein the second composition is a liquid composition, and the liquid composition comprises less than 5% by weight of the liquid composition of a structuring agent, less than 15% by weight of the unit dose article of water and between 5% and 35% by weight of the unit dose article of non-aqueous solvent, and
wherein the weight ratio of the first composition to the second composition is between 2:1 and 1:25.

The water-soluble unit dose article comprises at least one water-soluble film shaped such that the unit-dose article comprises at least two internal compartments surrounded by the water-soluble film.

The water-soluble film is sealed such that first and second compositions do not leak out of the compartments during storage. However, upon addition of the water-soluble unit dose article to water, the water-soluble film dissolves and releases the contents of the internal compartments into the wash liquor.

The compartment should be understood as meaning a closed internal space within the unit dose article, which holds the composition. Preferably, the unit dose article comprises a water-soluble film. The unit dose article is manufactured such that the water-soluble film completely surrounds the compositions and in doing so defines the compartments in which the compositions reside. The unit dose article may comprise two films. A first film may be shaped to comprise at least one open compartment into which a composition is added. A second film is then laid over the first film in such an orientation as to close the opening of the compartment. The first and second films are then sealed together along a seal region. The film is described in more detail below.

The unit dose article comprises at least two compartments, or even at least three compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

The first and second compartments may be joined to one another, preferably wherein they are joined in a side-by-side orientation or a superposed orientation.

One of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

The water-soluble unit dose article comprises a first composition. The first composition is described in more detail below.

The water-soluble unit dose article comprises a second composition. The second composition is described in more detail below.

The water-soluble unit dose article comprises a water-soluble film. Water-soluble films are described in more detail below.

The ratio of the first composition to the second composition is between 2:1 and 1:25, preferably between 2:1 and 1:15.

The ratio of the first composition to the second composition may be between 2:1 and 1:3, preferably between 1.5:1 and 1:2.5, more preferably between 1:1 and 1:2.

The ratio of the first composition to the second composition may be between 1:25 and 1:10, preferably between 1:20 and 1:10.

The water-soluble unit dose article may further comprise aversive agent within the water-soluble film. The aversive agent within the water-soluble film and the aversive agent coated onto the unit dose article maybe the same aversive agent or may be different.

The water-soluble unit dose article may comprise an air bubble.

The water-soluble unit dose article may be transparent, translucent or opaque.

The water-soluble unit dose article may comprise between 10% and 30%, preferably between 15% and 30% by weight of the water-soluble unit dose article of a non-aqueous solvent.

The non-aqueous solvent may be selected from glycerol, 1,2-propanediol, 1,3-propanediol, dipropylene glycol, ethanol, polypropylene glycol and mixtures thereof.

Preferably the water-soluble unit dose article comprises less than 15% by weight of the unit dose article of water. The water-soluble unit dose article may comprise between 0.1% and 15%, preferably between 2% and 13.5% by weight of the unit dose article of water.

The water-soluble unit dose article may comprise an aversive agent. The aversive agent may be comprised within the water-soluble film, on the outside of the unit dose article, in the first composition, in the second composition or a mixture thereof. Suitable aversive agents are described below.

The water-soluble unit dose article may comprise an anionic surfactant, wherein the anionic surfactant preferably comprises a linear alkylbenzene sulphonate, an alkyl alkoxylated sulphate, a carboxylate anionic surfactant or a mixture thereof. More preferably, the liquid composition comprises said anionic surfactant. The water-soluble unit dose article may comprise a non-ionic surfactant, preferably an alkoxylated fatty alcohol, an oxo-synthesised non-ionic surfactant, a Guerbet alcohol non-ionic surfactant, glycereth cocoate or a mixture thereof. The first composition, the second composition or both may comprises the non-ionic surfactant.

Without wishing to be bound by theory, by formulating the softening active into the powder composition the requirement for structuring agent is removed. In the powder form, the softening active is not seen to deposit. It is believed that the powder composition offers the added benefit of reducing the dissolution of the softening active into the wash long enough to allow cleaning actives to first interact with the fabrics ahead of the softening actives, and so maximizing the cleaning benefit seen. It was also surprisingly found that careful balance of the weight ratio of the powder composition to the liquid composition provided the added benefit of reducing fabric residues/poor dissolution of the powder composition in cold and quick wash cycles. Without wishing to be bound by theory, in cold and quick wash cycles, powder compositions sometimes do not dissolve fully due to the cold temperatures and short times for dissolution. Careful balance of the weight ratio of the powder to the liquid achieves sufficient reduction in dissolution of the powder to allow the cleaning actives to interact with the fabrics ahead of the softening actives, but also minimizing fabric residues from undissolved powders during cold and quick wash cycles.

The water-soluble article may comprise a perfume, an encapsulated perfume, a perfume contained on a carrier or a mixture thereof.

First Composition

The first composition is a free flowing non-compressed particulate composition. Free flowing non-compressed particulate compositions are those in which the particles have not been compressed under pressure of another means to form for example a tablet. Under the force of gravity the particles in the first composition would be seen to flow freely of one another. However, free flowing particulate forms should be understood to not encompass liquid forms.

The first compartment may comprise between 1% and 100% by weight of the first compartment of the first composition, or even between 1% and 75% or between 1% and 50%, or between 1% and 40% by weight of the first compartment of the first composition.

The first composition comprises a fabric softening ingredient. Preferably, the fabric softening ingredient is present between 0.1% and 40%, more preferably between 1% and 30%, most preferably between 2% and 20% by weight of the unit dose article.

Preferably, the particles comprise between 1% and 100% by weight of the particles of the fabric softening ingredient. In other words, each particle comprises between 1% and 100% by weight of the particle of the softening ingredient. More preferably, the particles comprise between 20% and 95%, most preferably between 50% and 90% by weight of the particles of the fabric softening ingredient.

The first composition may have an average particle size distribution of between 100 microns and 1000 microns. The particle size distributions are measured by sieving the granules through a succession of sieves with gradually smaller dimensions. The weight of material retained on each sieve is then used to calculate a particle size distribution.

The average Particle Size of the subject particle may be measured using ASTM D 502-89, “Standard Test Method for Particle Size of Soaps and Other Detergents”, approved May 26, 1989, with a further specification for sieve sizes used in the analysis. Following section 7, “Procedure using machine-sieving method,” a nest of clean dry sieves containing U.S. Standard (ASTM E 11) sieves #8 (2360 mu m), #12 (1700 mu m), #16 (1180 mu m), #20 (850 mu m), #30 (600 mu m), #40 (425 mu m), #50 (300 mu m), #70 (212 mu m), and #100 (150 mu m) is required. The prescribed Machine-Sieving Method is used with the above sieve nest. The detergent granule of interest is used as the sample. A suitable sieve-shaking machine can be obtained from W.S. Tyler Company of Mentor, Ohio, U.S.A. The data are plotted on a semi-log plot with the micron size opening of each sieve plotted against the logarithmic abscissa and the cumulative mass percent (Q3) plotted against the linear ordinate.

The fabric softening ingredient is described in more detail below.

The first composition may comprise particles comprising;
a. between 45% and 95% by weight of the particles of a carrier selected from polyethylene glycol, polyvinyl alcohol, urea, polyurethane, silica or mixtures thereof;
b. between 1% and 50% by weight of the particles of the fabric softening ingredient and
c. less than 20% by weight of the particles of a surfactant.

### Second Composition

The second composition is a liquid composition. By ‘liquid’ we herein mean any composition capable of wetting and treating a substrate and encompasses forms such as dispersions, gels, pastes and mixtures thereof. A dispersion, for example, is a liquid comprising solid or particulate matter contained therein. The liquid composition may also include gases in suitably subdivided form. Liquid form should be understood to not include particulate forms.

The second composition comprises less than 5% by weight of the second composition of a structuring agent. The structurant may be selected from non-polymeric or polymeric structurants. The structurant is described in more detail below.

The second composition may comprise an anionic surfactant. The anionic surfactant preferably comprises a linear alkylbenzene sulphonate, an alkyl alkoxylated sulphate, a carboxylate anionic surfactant or a mixture thereof.

Exemplary linear alkylbenzene sulphonates are C₁₀-C₁₆ alkyl benzene sulfonic acids, or C₁₁-C₁₄ alkyl benzene sulfonic acids. By ‘linear’, we herein mean the alkyl group is linear. The alkyl sulphate anionic surfactant may be a C₁₀-C₁₈ alkyl ethoxy sulfate (AEₓS) wherein x is an average degree of ethoxylation of from 0.5 to 30, preferably between 1 and 10, more preferably between 1 and 5.

Preferably the second composition comprises less than 2%, more preferably less than 1% by weight of the second composition of a fabric softening ingredient. The second compartment may be substantially free of a fabric softening ingredient. By ‘substantially free’ we herein mean that no fabric softening ingredient has purposively been added to the second composition.

### Fabric Softening Ingredient

The first composition comprises a fabric softening ingredient. The fabric softening ingredient is preferably selected from the group comprising quaternised polymers, non-quaternised cellulosic polymers, quaternary amines, clays, sucrose esters, silicones, and mixtures thereof. More preferably the fabric softening ingredient is selected from quaternised cellulosic polymers, quaternary ammonium compounds, silicone doped clays and mixtures thereof.

The fabric softening ingredient may comprise a quaternised polymer, wherein the quaternised polymer has a molecular weight of between 30,000 Da and 2,000,000 Da. The quaternised polymer may have a charge density of between 0.1% and 5% nitrogen.

The fabric softening ingredient may comprise a hydroxyethyl cellulose, hydroxypropyl cellulose or mixtures thereof.

The hydroxyethylcellulose may comprise a hydrophobically modified hydroxyethylcellulose. By ‘hydrophobically modified’, we herein mean that one or more hydrophobic groups are bound to the polymer backbone. The hydrophobic group may be bound to the polymer backbone via an alkylene group, preferably a C₁₋₆ alkylene group.

Preferably, the hydrophobic group is selected from linear or branched alkyl groups, aromatic groups, polyether groups, or a mixture thereof.

The hydrophobic group may comprise an alkyl group. The alkyl group may have a chain length of between C₈ and C₅₀, preferably between C₈ and C₂₆, more preferably between C₁₂ and C₂₂, most preferably between C₁₆ and C₂₀.

The hydrophobic group may comprise a polyalkylene glycol, preferably wherein the polalkylene glycol is selected from polyethylene glycol, polypropylene glycol, or a mixture thereof. The polyethylene glycol may comprise a copolymer comprising oxyethylene and oxypropylene units. The copolymer may comprise between 2 and 30 repeating units, wherein the terminal hydroxyl group of the polyalkylene glycol is preferably esterified or etherized. Preferably, the ester bond is formed with an acid selected from a C₅₋₅₀ carboxylic acid, preferably C₈₋₂₆ carboxylic acid, more preferably C₁₆₋₂₀ carboxylic acid, and wherein the ether bond is preferably formed with a C₅₋₅₀ alcohol, more preferably C₈₋₂₆ alcohol, most preferably a C₁₆₋₂₀ alcohol.

The hydroxyethyl cellulose may be derivatised with trimethyl ammonium substituted epoxide. The polymer may have a molecular weight of between 100,000 and 800,000 daltons.

The hydroxyethyl cellulose may have repeating substituted anhydroglucose units that correspond to the general Structural Formula I as follows:

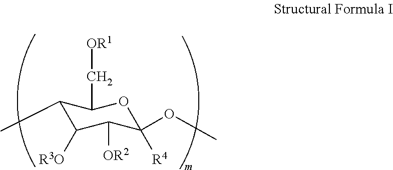

wherein:
a. m is an integer from 20 to 10,000
b. Each R4 is H, and R¹, R², R³ are each independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl, and

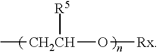

Preferably, R¹, R², R³ are each independently selected from the group consisting of: H; C₁-C₄ alkyl;

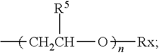

and mixtures thereof;

wherein:

n is an integer selected from 0 to 10 and

Rx is selected from the group consisting of: H;

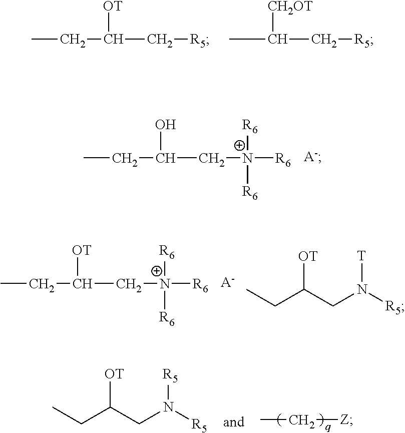

preferably Rx has a structure selected from the group consisting of: H;

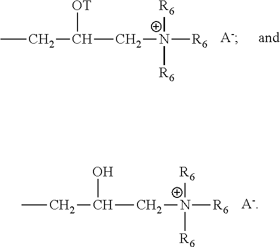

wherein A⁻ is a suitable anion. Preferably, A⁻ is selected from the group consisting of: Cl⁻, Br⁻, I⁻, methylsulfate, ethylsulfate, toluene sulfonate, carboxylate, and phosphate;

Z is selected from the group consisting of carboxylate, phosphate, phosphonate, and sulfate.

q is an integer selected from 1 to 4;

each R₅ is independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, and OH. Preferably, each R₅ is selected from the group consisting of: H, C₁-C₃₂ alkyl, and C₁-C₃₂ substituted alkyl. More preferably, R₅ is selected from the group consisting of H, methyl, and ethyl.

Each R₆ is independently selected from the group consisting of: H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted alkylaryl. Preferably, each R₆ is selected from the group consisting of: H, C₁-C₃₂ alkyl, and C₁-C₃₂ substituted alkyl.

Each T is independently selected from the group: H,

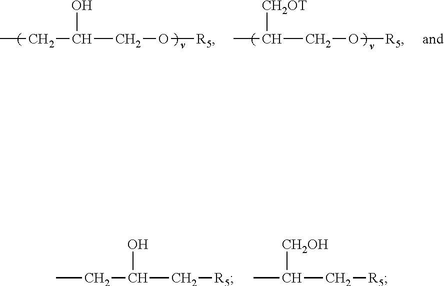

wherein each v in said polysaccharide is an integer from 1 to 10. Preferably, v is an integer from 1 to 5. The sum of all v indices in each Rx in said polysaccharide is an integer from 1 to 30, more preferably from 1 to 20, even more preferably from 1 to 10. In the last

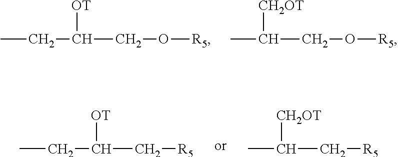

group in a chain, T is always an H.

Alkyl substitution on the anhydroglucose rings of the polymer may range from 0.01% to 5% per glucose unit, more preferably from 0.05% to 2% per glucose unit, of the polymeric material.

The hydroxyethylcellulose may be lightly cross-linked with a dialdehyde, such as glyoxal, to prevent forming lumps, nodules or other agglomerations when added to water at ambient temperatures.

The polymers of Structural Formula I likewise include those which are commercially available and further include materials which can be prepared by conventional chemical modification of commercially available materials. Commercially available cellulose polymers of the Structural Formula I type include those with the INCI name Polyquaternium 10, such as those sold under the trade names: Ucare Polymer JR 30M, JR 400, JR 125, LR 400 and LK 400 polymers; Polyquaternium 67 such as those sold under the trade name Softcat SK™, all of which are marketed by Amerchol Corporation, Edgewater N.J.; and Polyquaternium 4 such as those sold under the trade name: Celquat H200 and Celquat L-200, available from National Starch and Chemical Company, Bridgewater, N.J. Other suitable polysaccharides include hydroxyethyl cellulose or hydoxypropylcellulose quaternized with glycidyl C₁₂-C₂₂ alkyl dimethyl ammonium chloride. Examples of such polysaccharides include the polymers with the INCI names Polyquaternium 24 such as those sold under the trade name Quaternium LM 200 by Amerchol Corporation, Edgewater N.J.

Suitable cationic polymers may include the polyquaternium polymers, as in the CTFA Cosmetic Ingredient Dictionary (The Cosmetic, Toiletry and Fragrance, Inc. 1997), in particular the polyquaternium-6, polyquaternium-7, polyquaternium-10 polymers (Ucare Polymer IR 400; Amerchol), also referred to as merquats, polyquaternium-4 copolymers, such as graft copolymers with a cellulose backbone and quaternary ammonium groups which are bonded via allyldimethylammonium chloride, cationic cellulose derivatives, such as cationic guar, such as guar hydroxypropyltriammonium chloride, and similar quaternized guar derivatives (e.g. Cosmedia Guar, manufacturer: BASF GmbH), cationic quaternary sugar derivatives (cationic alkyl polyglucosides), e.g. the commercial product Glucquat® 100, according to CTFA nomenclature a “Lauryl Methyl Gluceth-10 Hydroxypropyl Dimonium Chloride”, copolymers of PVP and dimethylaminomethacrylate, copolymers of vinylimidazole and vinylpyrrolidone, aminosilicone polymers and copolymers.

It is likewise possible to use polyquaternized polymers (e.g. Luviquat Care from BASF) and also cationic biopolymers based on chitin and derivatives thereof, for example the polymer obtainable under the trade name Chitopharm® (manufacturer: BASF).

Likewise suitable materials according to the invention include cationic silicone oils, such as, for example, the commercially available products Q2-7224 (manufacturer: Dow Corning; a stabilized trimethylsilylamodimethicone), Dow Corning 929 emulsion (comprising a hydroxyl-amino-modified silicone, which is also referred to as amodimethicone), SM-2059 (manufacturer: General Electric), SLM-55067 (manufacturer: Wacker) Abil®-Quat 3270 and 3272 (manufacturer: Evonik; diquaternary polydimethylsiloxanes, quaternium-80) and Siliconquat Rewoquat® SQ 1 (Tegopren® 6922, manufacturer: Evonik).

The fabric softening active may comprise a sucrose ester. Sucrose ester is composed of a sucrose moiety having one or more of its hydroxyl groups esterified.

Sucrose is a disaccharide having the following formula:

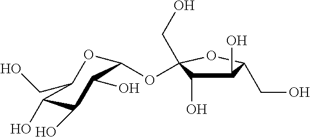

Alternatively, the sucrose molecule can be represented by the formula: M(OH)₈, wherein M is the disaccharide backbone and there are total of 8 hydroxyl groups in the molecule.

Thus, sucrose esters can be represented by the following formula:

M(OH)₈₋ₓ(OC(O)R¹)ₓ

wherein x is the number of hydroxyl groups that are esterified, whereas (8−x) is the hydroxyl groups that remain unchanged; x is an integer selected from 1 to 8, alternatively from 2 to 8, alternatively from 3 to 8, or from 4 to 8; and R¹ moieties are independently selected from C₁-C₂₂ alkyl or C₁-C₃₀ alkoxy, linear or branched, cyclic or acyclic, saturated or unsaturated, substituted or unsubstituted.

The R¹ moieties may comprise linear alkyl or alkoxy moieties having independently selected and varying chain length. For example, R¹ may comprise a mixture of linear alkyl or alkoxy moieties wherein greater than about 20% of the linear chains are C₁₈, alternatively greater than about 50% of the linear chains are C₁₈, alternatively greater than about 80% of the linear chains are C₁₈.

The R¹ moieties may comprise a mixture of saturate and unsaturated alkyl or alkoxy moieties; the degree of unsaturation can be measured by “Iodine Value” (hereinafter referred as “IV”, as measured by the standard AOCS method). The IV of the sucrose esters suitable for use herein ranges from about 1 to about 150, or from about 2 to about 100, or from about 5 to about 85. The R¹ moieties may be hydrogenated to reduce the degree of unsaturation. In the case where a higher IV is preferred, such as from about 40 to about 95, then oleic acid and fatty acids derived from soybean oil and canola oil are the starting materials.

The unsaturated R¹ moieties may comprise a mixture of “cis” and “trans” forms about the unsaturated sites. The “cis”/“trans” ratios may range from about 1:1 to about 50:1, or from about 2:1 to about 40:1, or from about 3:1 to about 30:1, or from about 4:1 to about 20:1.

### Structurant

The structurant may be a non-polymeric structurant, preferably a crystallisable glyceride. The structurant may be a polymeric structurant, preferably a fibre based polymeric structurant, more preferably a cellulose fibre-based structurant. The structurant may be selected from crystallisable glyceride, cellulose-fibre based structurants, TiO₂, silica and mixtures thereof.

Suitable structurants are preferably ingredients which impart a sufficient yield stress or low shear viscosity to stabilize the liquid laundry detergent composition independently from, or extrinsic from, any structuring effect of the detersive surfactants of the composition. Preferably, they impart to the laundry detergent composition a high shear viscosity at 20 sec-1 at 21° C. of from 1 to 1500 cps and a viscosity at low shear (0.05 sec-1 at 21° C.) of greater than 5000 cps. The viscosity is measured using an AR 550 rheometer from TA instruments using a plate steel spindle at 40 mm diameter and a gap size of 500 μm. The high shear viscosity at 20 s⁻¹ and low shear viscosity at 0.5 s⁻¹ can be obtained from a logarithmic shear rate sweep from 0.1-1 to 25-1 in 3 minutes time at 21° C.

The composition may comprise a non-polymeric crystalline, hydroxyl functional structurant. Such non-polymeric crystalline, hydroxyl functional structurants generally comprise a cystallizable glyceride which can be pre-emulsified to aid dispersion into the final liquid laundry detergent composition. A non-limiting example of such a pre-emulsified external structuring system comprises: (a) crystallizable glyceride(s); (b) anionic surfactant; and (c) water and optionally, non-aminofunctional organic solvents. Each of these components is discussed in detail below.

The structurant may be a polymeric crystalline, hydroxy-functional structurant that comprises a crystallizable glyceride, preferably hydrogenated castor oil or “HCO”. HCO as used herein most generally can be any hydrogenated castor oil or derivative thereof, provided that it is capable of crystallizing in the non-polymeric crystalline, hydroxy-functional structurant premix. Castor oils may include glycerides, especially triglycerides, comprising C₁₀ to C₂₂ alkyl or alkenyl moieties which incorporate a hydroxyl group. Hydrogenation of castor oil, to make HCO, converts the double bonds which may be present in the starting oil as ricinoleyl moieties. As such, the ricinoleyl moieties are converted into saturated hydroxyalkyl moieties, e.g., hydroxystearyl. The HCO herein may be selected from: trihydroxystearin; dihydroxystearin; and mixtures thereof. The HCO may be processed in any suitable starting form, including, but not limited to those selected from solid, molten and mixtures thereof. HCO is typically present at a level of from 2% to 10%, from 3% to 8%, or from 4% to 6% by weight in the external structuring system. The corresponding percentage of hydrogenated castor oil delivered into a finished laundry detergent product may be below 1.0%, typically from 0.1% to 0.8%. HCO may be present at a level of between 0.01% and 1%, or even between 0.05% and 0.8% by weight of the laundry detergent composition.

HCO of use in the present invention includes those that are commercially available. Non-limiting examples of commercially available HCO of use in the present invention include: THIXCIN® from Rheox, Inc. Further examples of useful HCO may be found in U.S. Pat. No. 5,340,390.

While the use of hydrogenated castor oil is preferred, any crystallisable glyceride can be used within the scope of the invention. Preferred crystallisable glyceride(s) have a melting point of from 40° C. to 100° C.

The structurant may comprise a fibre-based structurant. The structurant may comprise a microfibrillated cellulose (MFC), which is a material composed of nanosized cellulose fibrils, typically having a high aspect ratio (ratio of length to cross dimension). Typical lateral dimensions are 1 to 100, or 5 to 20 nanometres, and longitudinal dimension is in a wide range from nanometres to several microns. For improved structuring, the microfibrillated cellulose preferably has an average aspect ratio (l/d) of from 50 to 200,000, more preferably from 100 to 10,000. Microfibrillated cellulose can be derived from any suitable source, including bacterial cellulose, citrus fibers, and vegetables such as sugar beet, chicory root, potato, carrot, and the like.

### Aversive Agent

As used herein, an aversive agent is an agent that is intended to discourage ingestion and/or consumption of the unit dose articles described herein or components thereof, such as water-soluble films. An aversive agent may act by providing an unpleasant sensation, such as an unpleasant taste, when placed in the mouth or ingested. Such unpleasant sensations may include bitterness, pungency (or heat/spiciness), an unpleasant odor, sourness, coldness, and combinations thereof. An aversive agent may also act by causing humans and/or animals to vomit, for example via emetic agents. Suitable aversive agents include bittering agents, pungent agents, emetic agents, and mixtures thereof.

The level of aversive agent used may be at least at an effective level, which causes the desired aversive effect, and may depend on the characteristics of the specific aversive agents, for example bitter value. The level used may also be at or below such a level that does not cause undesired transfer of the aversive agents to a human and/or animal, such as transfer to hands, eyes, skin, or other body parts. The aversive agent may be present at a concentration which elicits repulsive behavior within a maximum time of six seconds in cases of oral exposure.

The aversive agent may be selected from the group comprising naringin; sucrose octaacetate; denatonium benzoate; capsicinoids (including capsaicin); vanillyl ethyl ether; vanillyl propyl ether; vanillyl butyl ether; vanillin propylene; glycol acetal; ethylvanillin propylene glycol acetal; gingerol; 4-(1-menthoxymethyl)-2-(3′-methoxy-4′-hydroxy-phenyl)-1,3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof. Other suitable aversive agents are described in more detail below.

### Water-Soluble Film

The film of the present invention is soluble or dispersible in water.

The water-soluble film preferably has a thickness of from 20 to 200 microns, preferably 35 to 150 microns, even more preferably 50 to 125 microns, most preferably from 75 to 100 microns, or 76 microns, or 100 microns. Preferably, the water-soluble film prior to being made into a water-soluble unit dose article has a thickness between 20 μm and 200 μm, preferably between 35 μm and 150 μm, even more preferably between 50 μm and 125 μm, most preferably between 75 μm and 100 μm or 76 microns, or 100 microns. Herein we mean the thickness of the film before it has been subjected to any thermoforming, elastic strain or plasticization techniques such as thermoforming into a mould for example or stretching from general film handling.

Different film material and/or films of different thickness may be employed in making the compartments of the present invention. A benefit in selecting different films is that the resulting compartments may exhibit different solubility or release characteristics.

Preferred films exhibit good dissolution in cold water, meaning unheated distilled water. Preferably such films exhibit good dissolution at temperatures 24° C., even more preferably at 10° C. By good dissolution it is meant that the film exhibits water-solubility of at least 50%, preferably at least 75% or even at least 95%, as measured, by the method set out here after using a glass-filter with a maximum pore size of 20 microns, described below. Water-solubility may be determined at 24° C., or preferably at 10° C.

Dissolution Method: 50 Grams±0.1 Gram of Film Material is Added in a Pre-Weighed 400 ml beaker and 245 ml±1 ml of distilled water is added. This is stirred vigorously on a magnetic stirrer, labline model No. 1250 or equivalent and 5 cm magnetic stirrer, set at 600 rpm, for 30 minutes at 24° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion, or blown extrusion of the polymeric material, as known in the art. Preferably the film is obtained by an extrusion process or by a casting process.

Preferred polymers (including copolymers, terpolymers, or derivatives thereof) suitable for use as film material are selected from polyvinyl alcohols (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the polymers of the film material are free of carboxylate groups.

Preferably, the level of polymer in the film material, for example a PVA polymer, is at least 60%. The polymer can have any weight average molecular weight, preferably from about 1000 to 1,000,000, more preferably from about 10,000 to 300,000, yet more preferably from about 20,000 to 150,000.

Mixtures of polymers can also be used as the film material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000 to about 40,000, preferably about 20,000, and of PVA or copolymer thereof, with a weight average molecular weight of about 100,000 to about 300,000, preferably about 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers, preferably polyvinyl alcohol, which are from about 60% to about 99% hydrolysed, preferably from about 80% to about 99% hydrolysed, even more preferably from about 80% to about 90% hydrolysed, to improve the dissolution characteristics of the material. Preferred films are those supplied by Monosol (Merrillville, Ind., USA) under the trade references M8630, M8900, M8779, M8310, M9467, and PVA films of corresponding solubility and deformability characteristics. Other suitable films may include called Solublon® PT, Solublon® GA, Solublon® KC or Solublon® KL from the Aicello Chemical Europe GmbH, the films VF-HP by Kuraray, or the films by Nippon Gohsei, such as Hi Selon. Suitable films include those supplied by Monosol for use in the following Procter and Gamble products: TIDE PODS, CASCADE ACTION PACS, CASCADE PLATINUM, CASCADE COMPLETE, ARIEL 3 IN 1 PODS, TIDE BOOST ORIGINAL DUO PACs, TIDE BOOST FEBREZE SPORT DUO PACS, TIDE BOOST VIVID WHITE BRIGHT PACS, DASH, FAIRY PLATINUM. It may be preferable to use a film that exhibits better dissolution than M8630 film, supplied by Monosol, at temperatures 24° C., even more preferably at 10° C.

Preferred water soluble films are those derived from a resin that comprises a blend of polymers, preferably wherein at least one polymer in the blend is polyvinyl alcohol. Preferably, the water soluble film resin comprises a blend of PVA polymers. For example, the PVA resin can include at least two PVA polymers, wherein as used herein the first PVA polymer has a viscosity less than the second PVA polymer.

The film material herein can also comprise one or more additive ingredients. For example, the film preferably comprises a plasticizing agent. The plasticizing agent may comprise water, glycerol, ethylene glycol, diethylene glycol, propylene glycol, diproypylene glycol, sorbitol, or mixtures thereof. In some aspects, the film comprises from about 2% to about 35%, or from about 5% to about 25%, by weight of the film, a plasticizing agent selected from group comprising water, glycerol, diethylene glycol, sorbitol, and mixtures thereof. In some aspects, the film material comprises at least two, or preferably at least three, plasticizing agents. In some aspects, the film is substantially free of ethanol, meaning that the film comprises from 0% (including 0%) to about 0.1% ethanol by weight of the film. In some aspects, the plasticizing agents are the same as solvents found in an encapsulated liquid composition.

Other additives may include water and functional detergent additives, including surfactant, to be delivered to the wash water, for example, organic polymeric dispersants, etc. Additionally, the film may comprise an aversive agent, further described herein.

The water-soluble unit dose article may comprise an area of print. The water-soluble unit dose article may be printed using flexographic techniques, ink jet printing techniques or a mixture thereof. The printed are may be on the film, preferably on the outside of the film, within the film, on the inside of the film or a mixture thereof. The printed area may convey information such as usage instructions, chemical safety instructions or a mixture thereof. Alternatively, the entire surface of the pouch, or substantially the entire surface of the pouch is printed in order to make the pouch opaque. The print may convey an image that reduces the risk of confusion and hence accidental ingestion of the pouch.

### Method Making

Those skilled in the art will be aware of how to manufacture a water-soluble unit dose article. An exemplary method is to deform a first water-soluble film into an appropriate mould to form one or more open cavities. The one or more cavities are filled with the first composition and/or second compositions. A second film is then used to close the one or more open cavities.

Those skilled in the art will know how to make the first composition. The first composition may be made using standard techniques such as spray drying, agglomeration, extruding or a mixture thereof.

A process of making the first composition may comprise pastillation processes, prilling processes, molding processes, extrusion processes, or a mixture thereof.

Such processes of making the first composition may comprise the steps of
providing a carrier material (preferably having a melting point of greater than 25° C.);
heating the carrier material (preferably to a temperature greater than the melting point of the carrier material),
mixing a benefit agent with the heated carrier material to form a melt composition; and
cooling the melt composition (preferably to a temperature below the melting point of the carrier material) to form the first composition.

A pastillation process for making the first composition generally comprises the steps recited above, wherein the step of cooling the melt composition comprises dispensing the melt composition drop-wise onto a cooling surface (i.e. a surface that is cooled relative to ambient temperature (e.g. 25° C.)).

A prilling process for making the first composition generally comprises the steps recited above, wherein the step of cooling the melt composition comprises dispensing the melt composition drop-wise into a cooling atmosphere (i.e. a controlled atmosphere in which the air is cooled relative ambient temperature (e.g. 25° C.)).

A molding process for making the first composition generally comprises the steps recited above, wherein the step of cooling the melt composition comprises dispensing the melt composition into a mold and further comprising the step of cooling the melt composition in the mold to form the particles of the first composition prior to releasing from the mold.

Those skilled in the art will know how to make the second composition using standard manufacturing and mixing techniques.

### Method of Use

The present invention is also to a method of doing laundry comprising the steps of diluting a water-soluble unit dose article according to the present invention in water by a factor of at least 400 to form a wash liquor and then washing fabrics with said wash liquor.

The unit dose article of the present invention may be used alone in the wash operation or may be used in conjunction with other laundry additives such as fabric softeners or fabric stain removers. The unit dose article may be used in conjunction with fragrance boosting compositions such as commercially available ‘Lenor Unstoppables’.

The temperature of the wash liquor may be between 10° C. and 90° C., preferably between 15° C. and 60° C., more preferably between 15° C. and 30° C. The wash process may take between 10 minutes and 3.5 hours. The wash process may comprise one or more wash cycles. At least one wash cycle may take between 5 minutes and 2 hours, preferably between 5 minutes and 60 minutes, more preferably between 5 minutes and 40 minutes. The wash process may comprise a combination of short and long cycles. Alternatively, the wash process may comprises a series of short cycles, so-called ‘quick wash’. The wash process may be a ‘quick wash’ at lower temperature.

The articles to be washed may be contacted with the wash liquor or the wash liquor may be contacted with the articles to be washed. Alternatively, the articles to be washed may be present within a washing machine and the wash liquor is formed around them.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### Examples

The following are examples of water-soluble unit dose articles of the present invention. Any first compartment 1A-1G may be present in a unit dose article with any second compartment 2A-2F. All water-soluble unit dose articles comprise a water-soluble polyvinyl alcohol containing film.

| Ingredients (All levels | | | | | | | | | | | | | |
|---|---|---|---|---|---|---|---|---|---|---|---|---|---|
| are in weight percent | Second Compartment | | | | | | First compartment | | | | | | |
| of the composition.) | 2A | 2B | 2C | 2D | 2E | 2F | 1A | 1B | 1C | 1D | 1E | 1F | 1G |
| Linear C₉-C₁₅ | 18.4 | 26.7 | 21.8 | 23.5 | 19.7 | 30.0 | 23.0 | | 23.0 | 23.0 | 23.0 | | 23.0 |
| Alkylbenzene | | | | | | | | | | | | | |
| sulfonic acid | | | | | | | | | | | | | |
| C12-14 alkyl | 8.7 | 7.6 | 14.8 | — | — | — | | | | | | | |
| ethoxy 3 sulfate or | | | | | | | | | | | | | |
| C12-15 alkyl | | | | | | | | | | | | | |
| ethoxy 2.5 sulfate | | | | | | | | | | | | | |
| C12-14 alkyl | — | — | — | — | — | — | 7.0 | | 7.0 | 7.0 | 7.0 | | 7.0 |
| ethoxy 1 sulfate or | | | | | | | | | | | | | |
| C12-15 alkyl | | | | | | | | | | | | | |
| ethoxy 1 sulfate | | | | | | | | | | | | | |
| C₁₂₋₁₄ alkyl 7- | 14.5 | 3.1 | 4.0 | 24.5 | 16.2 | 19.4 | | | | | | | |
| ethoxylated | | | | | | | | | | | | | |
| alcohol C₁₂₋₁₄ | | | | | | | | | | | | | |
| alkyl 9-ethoxylated | | | | | | | | | | | | | |
| alcohol or C₁₄₋₁₅ | | | | | | | | | | | | | |
| alkyl 7-ethoxylated | | | | | | | | | | | | | |
| alcohol (or mixture | | | | | | | | | | | | | |
| thereof) | | | | | | | | | | | | | |
| Methyl ester | — | — | — | — | — | — | 5.0 | | 5.0 | 5.0 | 5.0 | | 5.0 |
| sulfonate | | | | | | | | | | | | | |
| Citric Acid | 0.7 | 0.6 | 0.7 | — | — | — | | | | | | | |
| Fatty acid | 6.1 | 11.0 | 6.0 | 9.1 | 19.6 | 7.2 | | | | | | | |
| Soap | — | — | — | — | — | — | 1.5 | | 1.5 | 1.5 | 1.5 | | 1.5 |
| Sodium Carbonate | — | — | — | — | — | — | 6.6 | 3.94 | 6.6 | 6.6 | 6.6 | | 4.0 |
| Sodium | — | — | — | — | — | — | 12.0 | 12 | 12.0 | 12.0 | 12.0 | | 10.0 |
| Bicarbonate | | | | | | | | | | | | | |
| Sodium Silicate | — | — | — | — | — | — | 11.7 | 10.2 | 7.0 | 9.0 | 11.7 | | 5.0 |
| Tetraacetylethylenediamine | — | — | — | — | — | — | | 10.6 | | | | | |
| Sodium | — | — | — | — | — | — | | 30.1 | | | | | |
| percarbonate | | | | | | | | | | | | | |
| Sulfate | — | — | — | — | — | — | 10.6 | 10.6 | 6.0 | 8.3 | 9.5 | | 3.0 |
| Zeolite | — | — | — | — | — | — | 3.4 | 3.4 | 3.4 | 3.4 | 3.4 | | 0.0 |
| NaCl | — | — | — | — | — | — | 1.8 | 1.8 | 1.8 | 1.8 | 1.8 | | 1.0 |
| HEDP or DTPA or | 2.1 | 0.7 | 2.3 | 0.3* | 0.5* | 0.5* | | | | | | | |
| Diethylene | | | | | | | | | | | | | |
| triamine penta | | | | | | | | | | | | | |
| methylene | | | | | | | | | | | | | |
| phosphonic acid* | | | | | | | | | | | | | |
| Enzymes | 1.7 | 1.2 | 1.6 | 2.0 | 1.7 | 2.4 | 3.7 | 3.7 | 3.7 | 3.7 | 3.7 | | 2.8 |
| (protease, amylase, | | | | | | | | | | | | | |
| mannanase, | | | | | | | | | | | | | |
| cellulase, | | | | | | | | | | | | | |
| xyloglucanase, | | | | | | | | | | | | | |
| pectate lyase, | | | | | | | | | | | | | |
| lipase or mixture | | | | | | | | | | | | | |
| thereof, expressed | | | | | | | | | | | | | |
| as % enzyme raw | | | | | | | | | | | | | |
| material solutions) | | | | | | | | | | | | | |
| Brightener 49 | 0.3 | 0.3 | 0.4 | 0.3 | 0.3 | 0.4 | | | | | | | |
| Soil release | — | — | — | 0.10 | 0.12 | 0.15 | 1.0 | 1.0 | 1.0 | 1.0 | 1.0 | | 1.0 |
| polymer (SRA300 | | | | | | | | | | | | | |
| ex Clariant or | | | | | | | | | | | | | |
| Polypropylene | | | | | | | | | | | | | |
| terephthalate or | | | | | | | | | | | | | |
| Polyethylene | | | | | | | | | | | | | |
| terephthalate or | | | | | | | | | | | | | |
| mixtures thereof) | | | | | | | | | | | | | |
| Ethoxylated | 5.3 | 2.9 | 3.2 | 2.0 | 1.7 | 3.0 | | | | | | | |
| polyethylene imine | | | | | | | | | | | | | |
| PEI 600 E20 ex | | | | | | | | | | | | | |
| BASF | | | | | | | | | | | | | |
| PEG | 1.7 | — | 2.5 | — | — | — | | | | | | | |
| 6000/polyvinylacetate | | | | | | | | | | | | | |
| copolymer | | | | | | | | | | | | | |
| (40:60) ex BASF | | | | | | | | | | | | | |
| 1,2 Propanediol | 14.9 | 16.6 | 11.5 | 6.6 | 9.4 | 6.7 | | | | | | | |
| Glycerine | 5.0 | 4.8 | 3.8 | 4.7 | 2.0 | 12.0 | | | | | | | |
| Ethanol | — | — | — | 1.6 | — | 5.5 | | | | | | | |
| Water | 9.6 | 10.6 | 9.6 | 7.6 | 7.5 | 8.4 | | | | | | | |
| Di propylene | 0.2 | 0.5 | 4.0 | — | 12.0 | — | | | | | | | |
| glycol | | | | | | | | | | | | | |
| Antifoam AF8017 | — | — | 0.3 | — | — | — | | | | | | | |
| ex Dow Corning | | | | | | | | | | | | | |
| Perfume | 2.4 | 2.8 | 2.4 | 3.0 | 1.9 | 2.5 | 2 | 2 | 2 | 2 | 2 | | 2 |
| Perfume micro | — | 0.85 | — | — | — | — | 1.0 | 1.0 | 1.0 | 1.0 | 1.0 | | 1.0 |
| capsules | | | | | | | | | | | | | |
| (expressed as | | | | | | | | | | | | | |
| % encapsulated oil) | | | | | | | | | | | | | |
| Accusol 880 | — | — | — | — | — | — | | | | | | | |
| structurant ex | | | | | | | | | | | | | |
| DOW | | | | | | | | | | | | | |
| (as raw material ex | | | | | | | | | | | | | |
| supplier) | | | | | | | | | | | | | |
| PPG 400 | — | — | — | — | — | — | | | | | | | |
| Cationically | — | — | — | — | — | — | | | | | 1.0 | 100 | |
| modified hydroxy- | | | | | | | | | | | | | |
| ethyl cellulose* | | | | | | | | | | | | | |
| Carboxy methyl | — | — | — | — | — | — | 7.7 | 7.7 | 7.7 | 7.7 | 7.7 | | 7.7 |
| cellulose | | | | | | | | | | | | | |
| Hueing dye | — | — | — | — | — | — | | | | | | | |
| Sefose: Sucrose | | | | | | | | | | 5.0 | | | |
| Esters of Fatty Acids | | | | | | | | | | | | | |
| Polyethylene oxide | | | | | | | | | 0.2 | | | | |
| MW 300000 | | | | | | | | | | | | | |
| Montmorillonite | | | | | | | | | 10 | | | | |
| clay | | | | | | | | | | | | | |
| Structurant | 0.13 | 0.14 | 0.13 | — | — | — | | | | | | | |
| (hydrogenated | | | | | | | | | | | | | |
| castor oil) | | | | | | | | | | | | | |
| PDMS or amino | — | — | — | — | — | — | | | | | | | 2.5 |
| functionalized | | | | | | | | | | | | | |
| silicone or cationic | | | | | | | | | | | | | |
| or anionic silicone | | | | | | | | | | | | | |
| PEG 8000 | — | — | — | — | — | — | | | | | | | 21.0 |
| Perfume | — | — | — | — | — | — | | | | | | | 1.25 |
| Perfume micro | — | — | — | — | — | — | | | | | | | 0.25 |
| capsules (expressed | | | | | | | | | | | | | |
| as % encapsulated oil) | | | | | | | | | | | | | |

| | | |
|---|---|---|
| Mono-ethanolamine, | to between pH 7.0 and 8.7 | to between pH 8.5 and 10.0 (made as a |
| tri-ethanolamine or | | 1% solution in deionized water) |
| NaOH (or mixture thereof) | | |

| | |
|---|---|
| Other laundry | To 100% |
| adjuncts (sulfite, dyes, | |
| opacifiers, MgCl2, bitrex, | |
| minors, . . . ) | |

What is claimed is:

1. A multicompartment water-soluble unit dose article comprising at least a first compartment and a second compartment;
a. wherein the first compartment comprises a first composition wherein the first composition is a free-flowing non-compressed particulate composition, and wherein the first composition comprises a fabric softening ingredient; and
b. wherein the second compartment comprises a second composition wherein the second composition is a liquid composition, and the liquid composition comprises less than 5% by weight of the liquid composition of a structuring agent, less than 15% by weight of the unit dose article of water, and between 5% and 35% by weight of the unit dose article of non-aqueous solvent, and
wherein the weight ratio of the first composition to the second composition is between 2:1 and 1:25.

2. The water-soluble unit dose article according to claim 1 wherein the fabric softening ingredient is selected from the group comprising quaternised polymers, non-quaternised cellulosic polymers, quaternary amines, clays, sucrose esters, silicones, and mixtures thereof, preferably selected from quaternised cellulosic polymers, quaternary ammonium compounds, silicone doped clays and mixtures thereof.

3. The water-soluble article according to claim 2 wherein the molecular weight of the quaternised polymer is between 30,000 Da and 2,000,000 Da.

4. The water-soluble article according to claim 1 wherein the fabric softening ingredient comprises a hydroxyethyl cellulose, hydroxypropyl cellulose or mixtures thereof.

5. The water-soluble unit dose article according to claim 1 wherein the structuring agent is selected from the group comprising crystallisable glyceride, cellulose-fibre based structurants, TiO₂, silica and mixtures thereof.

6. The water-soluble unit dose article according to claim 1 wherein the first composition comprises particles comprising a first particle wherein the first particle comprises:
a. between 45% and 95% by weight of the first particle of a carrier selected from polyethylene glycol, polyvinyl alcohol, urea, polyurethane, silica or mixtures thereof;
b. between 1% and 50% by weight of the first particle of the fabric softening ingredient; and
c. less than 20% by weight of the first particle of a surfactant.

7. The water-soluble unit dose article according to claim 1 wherein the non-aqueous solvent is selected from glycerol, 1,2-propanediol, 1,3-propanediol, dipropylene glycol, polypropylene glycol, ethanol, and mixtures thereof.

8. The water-soluble article according to claim 1 comprising an anionic surfactant.

9. The water-soluble article according to claim 8, wherein the anionic surfactant comprises a linear alkylbenzene sulphonate, an alkyl alkoxylated sulphate, a carboxylate anionic surfactant, or a mixture thereof.

10. The water-soluble article according to claim 8, wherein the liquid composition comprises said anionic surfactant.

11. The water-soluble unit dose article according to claim 1 wherein the fabric softening ingredient is present between 0.1% and 40%, or even between 1% and 30%, or even between 2% and 20% by weight of the article.

12. The water-soluble article according to claim 1 comprising a perfume, an encapsulated perfume, a perfume contained on a carrier, or a mixture thereof.

13. The water-soluble unit dose article according to claim 1 wherein the first composition comprises particles, wherein the particles comprise between 1% and 100% by weight of the particles of the fabric softening ingredient.

14. The water-soluble unit dose article according to claim 1 wherein the first compartment comprises between 1% and 100% by weight of the first compartment of the first composition.

15. The water-soluble unit dose article according to claim 1 wherein the ratio of the first composition to the second composition is between 1.5:1 and 1:2.5.

16. The water-soluble unit dose article according to claim 15, wherein the ratio of the first composition to the second composition is between preferably between 1:1 and 1:2.

17. The water-soluble unit dose article according to claim 1 wherein the ratio of the first composition to the second composition is between 1:25 and 1:10, preferably between 1:20 and 1:10.

18. The water-soluble unit dose article according to claim 1 wherein the ratio of the first composition to the second composition is between 1:20 and 1:10.

19. The water-soluble unit dose article according to claim 1 wherein the first and second compartments are joined to one another.

20. The water-soluble unit dose article according to claim 19 wherein the first and second compartments are joined in a side-by-side orientation or a superposed orientation.
